(19) United States
(12) Patent Application Publication
(10) Pub. No.: US 2013/0161417 A1
(43) Pub. Date: Jun. 27, 2013

(54) Push-Button For A System For Dispensing A Product Under Pressure

(71) Applicant: Jean-Pierre Songbe, EU (FR)

(72) Inventor: Jean-Pierre Songbe, EU (FR)

(21) Appl. No.: 13/726,335

(22) Filed: Dec. 24, 2012

(30) Foreign Application Priority Data
Dec. 23, 2011 (FR) 11 62399

(51) Int. Cl. B05B 1/02

(52) U.S. Cl. CPC B05B 1/02
USPC 239/404

(57) ABSTRACT

A push-button for a system for dispensing a product under pressure, the push-button including a body having a mounting well on a feed tube for the pressurised product and a housing in communication with the well, the housing being provided with an anvil around which a spray nozzle is mounted in such a way as to form a path for dispensing the product between the housing and a swirl array including at least two swirl chambers, each of the swirl chambers including at least one supply channel in order to provide for the setting in rotation of the product in the chamber and a channel for dispensing a flow of product set in rotation, the dispensing channels each converging from an inlet orifice towards an outlet orifice according to an angle which is arranged in order to allow for the impaction of the flows of product dispensed by the channels.

### FIELD OF THE INVENTION

The invention relates to a push-button for a system for dispensing a product under pressure, as well as such a system for dispensing.

### BACKGROUND OF THE INVENTION

In a particular application, the system for dispensing is intended to be provided for bottles used in perfumery, cosmetics or for pharmaceutical treatments. Indeed, this type of bottle contains a liquid product which is returned by a system for dispensing comprising a device for the sampling under pressure of said product, said system being actuated by a push-button in order to allow for the spraying of the product. In particular, the device for sampling comprises a pump or valve actuated manually by the intermediary of the push-button.

Such push-buttons are conventionally carried out in two parts: an actuator body and a nozzle for spraying the product which are associated together in order to form a swirl array comprising a swirl chamber provided with a dispensing orifice as well as at least one supply channel of said chamber.

In particular, the supply channels can exit tangentially into the swirl chamber which is cylindrical of revolution in order to rotate the product very rapidly, the dispensing orifice having a reduced diameter in relation to that of said chamber so that the product in rotation escapes via said orifice at high speed and under a high pressure. The flow of product in rotation thus passes through a transitional phase of unstable flow, referred to as “pre-spray”, then breaks into droplets and forms the aerosol, also referred to as “spray”.

However, as this breaking is carried out in an uncontrolled manner, the aerosol is constituted of droplets with highly varied sizes. For example, for a pump or a valve supplying a push-button with a flow of alcohol under a pressure of 5 bars, and an outlet orifice of 0.3 mm, the aerosol is commonly constituted of droplets with a diameter between 5 μm and 300 μm.

However, the large droplets are heavier than the smaller droplets and follow a different dispensing trajectory, which can cause indelible stains in the case of perfumes. Also, the small droplets are the lightest and can be inhaled, which may be the objective sought in the case of medications, but can be an undesirable effect in the case of toxic products. Furthermore, in the case of medications that must be dispensed according to a precise dosage, the location of application, for example inside the respiratory system, depends on the size of the droplets, and the great disparity in sizes distorts the treatment.

Moreover, the size of the droplets coming from a swirl chamber depends in part on the forcer and the speed with which the user actuates the pump by pressing on the push-button with his finger, because the induced pressure depends on this.

Furthermore, in particular due to the effects of the centrifugal force at the output of the swirl chamber, the aerosol tends to be hollow, which is systematically the case when the product is not very viscous, in particular with a viscosity less than approximately 10 times that of water, and when the desired spray angle is greater than 45°. The envelope of the aerosol, of a substantially tapered shape at least in its first half, is constituted of the majority of the droplets while there are few of them inside the cone. This can be observed by projecting the aerosol on to a sheet of blotting paper: the wet area is annular although it should cover a disc. In particular, this distribution of droplets can be detrimental for dermal applications.

Finally, the user cannot break down the dose, i.e. return only a portion of the nominal dose provided by the pump, by limiting his course of pressing on the push-button. Indeed, the aerosol is produced in a manner that is too short, in particular of a magnitude of 0.2 seconds for 130 μm, to be able to be interrupted by the user.

In order to resolve the problems mentioned hereinabove, FR-2 903 328 proposes to use a non-swirl nozzle which is provided with a micro-grid in order to provide for the calibration and the spatial distribution of the droplets.

However, this embodiment requires sections of passage through the micro-grid which are extremely small, in particular of a magnitude of 6 μm in diameter, which imposes a fine filtration of the liquid in order to prevent the problems of clogging. Furthermore, the difficulty in carrying out and in assembling these micro-grids in the body remains high.

FR-2 915 470, in particular, discloses a push-button comprising a dispensing chamber which is provided with dispensing channels each converging towards an outlet orifice, said converging channels being arranged in order to allow for the impaction of streams of the product dispensed by said orifices. As such, during the impaction of the streams dispensed at high speed, an aerosol is formed without having recourse to a swirl chamber.

This embodiment enables in particular better control of the average size of the droplets and a low dispersion of their size. Furthermore, the quality of the aerosol is substantially independent of the force or of the speed of pressing on the push-button.

However, in order to carry out such an aerosol by satisfactorily controlling the calibration and the spatial distribution of the droplets, it is required to form streams that are identical, very fine and of which the convergence is perfect, which is very difficult to carry out industrially at the interface between the actuator body and the nozzle mounted in said body. This results in that the streams can cross without impacting each other or by impacting each other only partially, which degrades the calibration and the spatial distribution of the droplets formed, in particular by projecting parasite streams of the product.

Furthermore, when the pressure drops at the end of the dose, the impaction energy is no longer sufficient to form the aerosol and this therefore results in the production of a continuous stream of product.

### SUMMARY OF THE INVENTION

The invention aims to overcome the problems of prior art by proposing in particular a push-button that allows for the dispensing of an aerosol formed of droplets having an improved calibration and spatial distribution, and this is in a particularly reliable manner relatively to the restrictions of industrial manufacture in large series.

To this effect, and according to a first aspect, the invention proposes a push-button for a system for dispensing a product under pressure, said push-button comprising a body having a mounting well on a feed tube for the product under pressure and a housing in communication with said well, said housing being provided with an anvil around which a spray nozzle is mounted in such a way as to form a path for dispensing the product between said housing and a swirl array comprising at least two swirl chambers, with each of said swirl chambers comprising at least one supply channel in order to provide for the setting in rotation of the product in said chamber and a channel for dispensing a flow of product set in rotation, said dispensing channels each converging from an inlet orifice towards an outlet orifice according to an angle which is arranged in order to allow for the impaction of the flows of product dispensed by said channels.

According to a second aspect, the invention proposes a system for dispensing a product under pressure, comprising a device for sampling provided with a feed tube for the product under pressure whereon the well of such a push-button is mounted in order to allow for the spraying of the product.

### BRIEF DESCRIPTION OF THE DRAWINGS

Other objectives and advantages of the invention shall appear in the following description, made in reference to the annexed figures, wherein:

FIG. 1 is a partial longitudinal cross-section view of a bottle provided with a system for dispensing according to an embodiment of the invention;

FIG. 2 is a partial longitudinal cross-section view of the push-button of FIG. 1;

FIG. 3 is a partial transversal cross-section view of FIG. 2;

FIGS. 4a-4c are views of the spray nozzle of the push-button according to FIG. 2, respectively a stripped down perspective (FIG. 4a), a rear view (FIG. 4b) and as a longitudinal cross-section (FIG. 4c).

### DETAILED DESCRIPTION OF THE INVENTION

In relation to the figures, a push-button for a system for dispensing a product in particular a liquid product under pressure is described herein below, said product able to be of any nature, in particular used in perfumery, cosmetics or for pharmaceutical treatments.

The push-button comprises a body 1 having an annular skirt 2 which surrounds a mounting well 3 of the push-button on a feed tube 4 for the product under pressure. Moreover, the push-button comprises an upper zone 5 allowing the user to press with his finger on said push-button in order to be able to displace it axially. In the embodiment shown, the push-button is provided with a trim 6 which surrounds the body 1 and whereon is formed the upper zone 5 for pressing.

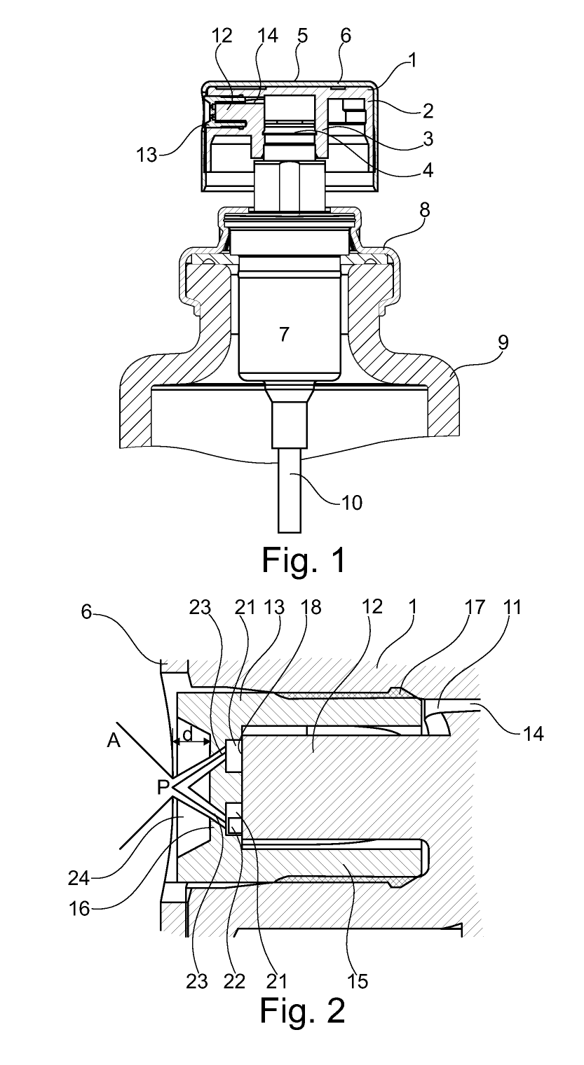

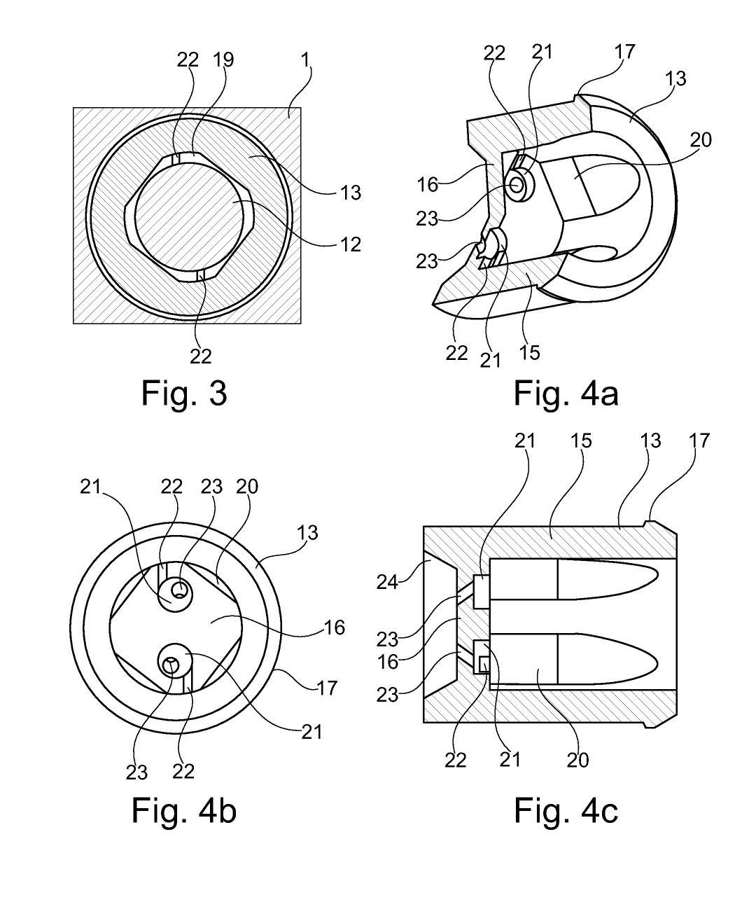

In relation with FIG. 1, the system for dispensing comprises a device for sampling 7 provided with a feed tube 4 for the product under pressure which is inserted in a sealed manner in the well 3. In a known manner, the system for dispensing further comprises means for mounting 8 on a bottle 9 containing the product and means for sampling 10 the product inside said bottle which are arranged in order to supply the feed tube 4 with the product under pressure.

The device for sampling 7 can include a manually-actuated pump or, in the case where the product is conditioned under pressure in the bottle 9, a manually-actuated valve. As such, during a manual displacement of the push-button, the pump or the valve is actuated to supply the feed tube 4 with the product under pressure.

The body 1 also has an annular housing 11 which is in communication with the well 3. In the embodiment shown, the housing 11 is with an axis perpendicular to that of the mounting well 3 in order to allow for a lateral spraying of the product relatively to the body 1 of the push-button. In an alternative not shown, the housing 11 can be collinear to the well 3, in particular for a push-button forming a nasal spray tip.

The housing 11 is provided with an anvil 12 around which a spray nozzle 13 is mounted in such a way as to form a path for dispensing the product under pressure between said housing and a swirl array. To do this, the anvil 12 extends from the bottom of the housing 11 by leaving a communication channel 14 between the well 3 and said housing.

In the embodiment shown, the nozzle 13 has a cylindrical lateral wall 15 of revolution which is closed towards the front by a proximal wall 16. The association of the nozzle 13 in the housing 11 is carried out by press fitting the external surface of the lateral wall 15, with the rear edge of said external surface being furthermore provided with a radial projection 17 for anchoring the nozzle 13 in said housing.

Moreover, an imprint of the swirl array is formed as a hollow in the proximal wall 16 and the anvil 12 has a distal wall 18 forming a planar bearing surface whereon the proximal wall 16 of the nozzle 13 is pressing in order to delimit the swirl array between said walls. In an alternative not shown, an imprint of the swirl array can be formed directly on a wall of the housing 11, in particular for a nasal spray tip.

Advantageously, the nozzle 13 and the body 1 are carried out via moulding, in particular of a different thermoplastic material. Furthermore, the material forming the nozzle 13 has a rigidity which is greater than the rigidity of the material forming the body 1. As such, the substantial stiffness of the nozzle 13 makes it possible to prevent it from being deformed when it is mounted in the housing 11 in such a way as to guarantee the geometry of the swirl array. Furthermore, the less substantial stiffness of the body 1 allows for an improved seal between the mounting well 3 and the feed tube 4.

In an example embodiment, the body 1 is made of polyolefin and the nozzle 13 is made of cycloolefin copolymer (COC), poly(oxymethylene) or poly(butylene teraphthalate).

In the embodiment shown, the internal surface of the lateral wall 15 of the nozzle 13 as well as the external surface of the anvil 12 have a cylindrical geometry of revolution which are arranged opposite in order to form the dispensing path between them. In particular, the dispensing path has axial ducts 19 which are each formed between two spacers 20 which extend over the internal surface of the lateral wall 15 of the nozzle 13.

The spacers 20 have a free wall which is arranged opposite the external surface of the anvil 12 with a reduced clearance in order to be able to provide for the centring of the nozzle 13 on the anvil 12 and therefore making the sealed closure of the swirl array between the walls 18, 16 reliable.

The swirl array comprises at least two swirl chambers 21 each comprising at least one supply channel 22 in order to provide for the setting in rotation of the product in said chamber and a channel for dispensing 23 a flow of product set in rotation. In particular, the swirl chambers 21 have a cylindrical geometry of revolution which is supplied tangentially by at least one supply channel 22, with the dispensing channel 23 formed on the distal end of said geometry.

In the embodiment shown, the swirl chambers 21 include a single supply channel 22 which is in communication with an axial duct 19, said supply channels extending radially in order to tangentially supply the swirl chambers 21. In particular, this embodiment makes it possible to reduce the induced pressure losses. Furthermore, each dispensing channel 23 has an inlet orifice which is off-centred opposite the supply channel 22 in order to allow for the ejection of the product set in rotation in the swirl chamber 21.

The dispensing channels 23 each converge from the inlet orifice towards an outlet orifice according to an angle which is arranged in order to allow for the impaction of the flows of product dispensed by said channels. The dispensing channels 23 can be carried out by laser drilling, or by injection under pressure of a rigid thermoplastic material such as a polyacetal, with the nozzle 13 then being able to be carried out in two parts, the proximal wall 16 and the lateral wall 15, in order to simplify the injection mould.

The impaction allows for the formation of the aerosol A but, in the case of an incomplete impaction, each flow is able to form an aerosol due to the setting in rotation of the product in the swirl chamber 21. In the embodiment shown, the swirl array comprises two chambers 21 for the impaction of two flows, but more than two swirl chambers 21 could be used, in particular three or four swirl chambers 21.

Advantageously, the impaction of the flows of product set in rotation is carried out during their transitional phase of unstable flow in order to favour the formation of the aerosol A via impaction. In particular, the distance d between the outlet orifices and the point P of impaction of the flows of product can be low, for example between 1 and 5 mm, in order to provide for the impaction of pre-sprays.

In the embodiment shown, the nozzle 13 has a front housing 24 wherein exit the outlet orifices, with the angle of convergence of the dispensing channels 23 being arranged in order to allow for the impaction of the flows of product inside said housing.

According to the invention, the formation of the aerosol A via impaction and/or by breaking down in the air is guaranteed, with water as well as with products with a higher surface tension, for example with alcohol-free perfumes containing surface active agents such as cremofor, emulgine, or silicones. In particular, the aerosols are homogeneous, constituted of droplets of very close sizes, and are particularly suited, for example, for inhalable medications, indoor fragrances, or make-up fixing products.

By way of example, for a pump of which the pressure is from 5 to 7 bars, the supply channels 22 are of a section of approximately 0.1 mm×0.1 mm, the diameter of the swirl chambers 21 is from 0.4 mm to 0.6 mm for a depth of 0.2 mm, the dispensing channels 23 are of a diameter 0.15 mm and converge for an impaction at point P at a distance d of 1 to 5 mm according to the surface tension of the product. The droplets constituting the aerosol A are then of an average size from 10 μm to 20 μm according to the product, and even less with a pump with a very high pressure for pharmaceutical applications.

1. A push-button for a system for dispensing a product under pressure, said push-button comprising a body having a mounting well on a feed tube for the product under pressure and a housing in communication with said well, said housing being provided with an anvil around which a spray nozzle is mounted in such a way as to form a path for dispensing the product between said housing and a swirl array comprising at least two swirl chambers, each of said swirl chambers comprising at least one supply channel in order to provide for the setting in rotation of the product in said chamber and a channel for dispensing a flow of product set in rotation, said dispensing channels each converging from an inlet orifice towards an outlet orifice according to an angle which is arranged in order to allow for the impaction of the flows of product dispensed by said channels.

2. The push-button according to claim 1, characterised in that the swirl chambers have a cylindrical geometry of revolution which is supplied tangentially by at least one supply channel.

3. The push-button according to claim 2, characterised in that each swirl chamber comprises a single supply channel with the inlet orifice of the dispensing channel being off-centred opposite said supply channel.

4. The push-button, according to claim 1, characterised in that the impaction of the flows of product set in rotation is carried out during their transitional phase of unstable flow.

5. The push-button according to claim 4, characterised in that the distance (d) between the outlet orifices and the point (P) of impaction of the flows of product is between 1 and 5 mm.

6. The push-button according to claim 1, characterised in that the nozzle has a proximal wall wherein is formed an imprint of the swirl array and the anvil has a distal wall forming a planar bearing surface whereon the proximal wall of the nozzle is pressing in order to delimit said swirl array between said walls.

7. The push-button according to claim 1, characterised in that the nozzle has a front housing wherein exit the outlet orifices, with the angle of convergence of the dispensing channels being arranged in order to allow for the impaction of the flows of product inside said housing.

8. The push-button according to claim 1, characterised in that the dispensing path has axial ducts, each supply channel communicating with one of said axial ducts.

9. The push-button according to claim 8, characterised in that each axial duct is formed between two spacers which extend over an internal surface of the nozzle.

10. A system for dispensing a product under pressure, comprising a device for sampling provided with a feed tube for the product under pressure whereon the well of a push-button according to claim 1 is mounted in order to allow for the spraying of the product.
